(19) United States
(12) Patent Application Publication
(10) Pub. No.: US 2017/0028865 A1
(43) Pub. Date: Feb. 2, 2017

(54) SYSTEM AND METHOD FOR MANAGING POWER CONSUMPTION

(71) Applicant: Nissan North America, Inc., Franklin, TN (US)

(72) Inventors: Heather Konet, Canton, MI (US); Alex Escutia, Warren, MI (US)

(21) Appl. No.: 14/814,915

(22) Filed: Jul. 31, 2015

(51) Int. Cl. B60L 11/18

(52) U.S. Cl. CPC B60L 11/1844; B60L 11/1846; B60L 11/1848

(57) ABSTRACT

To control and help reduce power consumption by a facility that has a plurality of EV charging stations, the present disclosure utilizes a system that includes a management device associated with the facility, a user's device, and a proximity device associated with one of the EV charging stations. The system performs a method that includes receiving an identification signal that is used to identify a set of users whose vehicles are connected to the plurality EV charging stations. The method also includes determining when a current level of power consumption by the facility exceeds a first threshold. A halt signal including a halt charging request message is transmitted when the current level of power consumption by the facility exceeds the first threshold level.

### TECHNICAL FIELD

The present disclosure relates to charging stations for electric vehicles, specifically for controlling power consumption by a facility associated with one or more electric vehicle charging stations.

### BACKGROUND

Electric vehicle (EV) charging stations can be installed proximate a parking space for a vehicle to draw electricity from the EV charging station to charge batteries or other power storage in the vehicle. Power consumption by the EV charging stations at a facility can significantly increase power consumption by the facility. Some examples of facilities include businesses, manufacturing facilities, office buildings, shopping malls, and other types of residential, industrial, and commercial buildings and compounds.

A problem exists with the current EV charging stations associated with a facility in that a high level of power demand and consumption may occur within a narrow period of time. For example, when a large number of employees charge vehicles at the facility during a daytime work shift, when the facility typically experiences a high power demand, the charging can cause an increased spike in power consumption by the facility. Accordingly, it is desired to have a system and method for controlling power consumption by a facility associated the multiple EV charging stations.

### SUMMARY

One aspect of the disclosed embodiments is a method for controlling power consumption by a facility that includes a plurality of EV charging stations. The facility is associated with a management device. The method includes receiving, by the management device, an identification signal including information identifying at least one of a user, a user's device, or a user's vehicle connected to one of the plurality of EV charging stations. The method further includes identifying, by the management device, in part on the basis of the identification signal, a set of users whose vehicles are connected to the plurality EV charging stations. The method also includes determining, by the management device, when a current level of power consumption by the facility exceeds a first threshold. Additionally the method includes transmitting, by the management device, a halt signal including a halt charging request message when the current level of power consumption by the facility exceeds the first threshold level.

Another aspect of the disclosed embodiment is a system for controlling power consumption by a facility including a plurality of EV charging stations. The system includes a management device associated with the facility, a proximity device associated with one of the plurality of EV charging stations, and a user device in communication with the management device associated with the facility. The user device is configured to transmit an identification signal including information identifying at least one of: the user; the user's device; or a user's vehicle connected to the EV charging station. The transmission of the identification signal occurring when the user device is in proximity of the proximity device. The user device is further configured to receive a halt signal including a halt charging request message. The management device is associated with the facility and is configured to receive the identification signal, to identify a set of users whose vehicles are connected to the plurality of EV charging stations on the basis of the identification signal, to determine when a current level of power consumption by the facility exceeds a first threshold, and to transmit the halt signal when the current level of power consumption by the facility exceeds the first threshold level.

### BRIEF DESCRIPTION OF THE DRAWINGS

The various features, advantages and other uses of the present apparatus will become more apparent by referring to the following detailed description and drawing in which:

FIG. 1 is an illustration of system components for reducing power consumption;

FIG. 2 is an illustration of varying power consumption of a facility over time;

FIG. 3 is a flow chart of a method to reduce power consumption;

FIG. 4 is a flow chart of another method to reduce power consumption;

FIG. 5 is a flow chart of another method to reduce power consumption;

FIG. 6 is a flow chart of another method to reduce power consumption; and

FIG. 7 is a flow chart of yet another method to reduce power consumption.

### DETAILED DESCRIPTION

Referring now to the numerous figures, wherein like references identify like elements, and the figures illustrate exemplary embodiments.

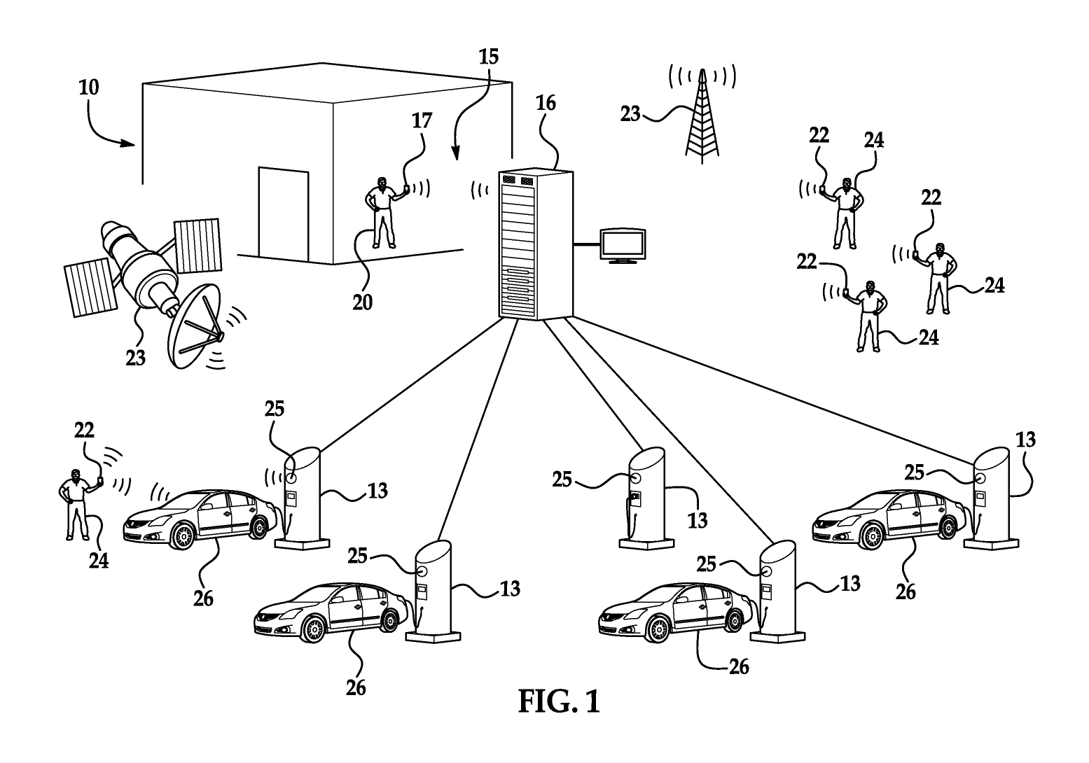

To control and help reduce power consumption by a facility 10 that has a plurality of EV charging stations 13, the present disclosure utilizes a system that includes a management device 15 associated with the facility 10, a user device 22, and a proximity device 25 associated with one of the EV charging stations 13, as shown in FIG. 1. The facility 10 is an architectural structure or group of structures with vehicle parking locations for persons utilizing the structure(s). The EV charging stations 13 may be located proximate to the parking locations of the facility 10. Consumption of power by the EV charging stations 13 is included in the overall power consumption by the facility. 10. Some examples of facilities include businesses, manufacturing facilities, office buildings, shopping malls, and other types of residential, industrial, and commercial buildings and compounds.

The management device 15 associated with the facility 10 in the exemplary embodiment is a server computer 16 and/or a portable computing device 17 with cellular capabilities operated by a facility manager 20. The server computer 16 and/or the portable computing device 17 includes an electronic control unit (ECU) with a processor, a communication unit, and an electronic storage device, all in communication with each other. The electronic storage device includes a non-transient tangible medium having machine readable instructions stored thereon that, when executed, enable the server computer 16 and/or the portable computing device 17 to perform the method disclosed herein. The communication unit may include a Bluetooth antenna, a Wi-Fi antenna, a cellular antenna, or any other suitable device known to those skilled in the art suitable to perform the functions of the present disclosure. Other devices known to those skilled in the art may be used as the management device, provided such devices are configurable to meet the requirements herein.

With reference again to FIG. 1, the user device 22 in the exemplary embodiment is a portable computing device with cellular and Bluetooth capabilities, such as a device commonly referred to as a smart phone. The user device 22 includes an ECU with a processor, a communication unit, and an electronic storage device, all in communication with each other. The electronic storage device includes non-transient tangible medium having machine readable instructions stored thereon that when executed enable the user device 22 to perform the method disclosed herein. The communication unit may include a Bluetooth antenna, a Wi-Fi antenna, a cellular antenna, or any other suitable device known to those skilled in the art suitable to perform the functions of the present disclosure.

The user device 22 is in communication with the server computer 16 and/or the portable computing device 17 of the management device 15 associated with the facility 10 by way of a cellular communication network 23, Wi-Fi, or other communication device, system, or protocol and combinations thereof known to those skilled in the art.

The user device 22 may be associated with a user 24 and a vehicle 26. For example, a database with defined associations between a user, a unique name, a telephone number, an IP address, a license plate number, or any other suitable information may be stored in a database on the user device 22, the management device 15, or any other location accessible by the management device 15 suitable for storing the database information, such as the internet storage system commonly referred to as “the cloud.” It is understood and appreciated that “the cloud” refers to one or more off-site locations accessible via the internet used for data processing and storage.

The proximity device 25 associated with one of the EV charging stations 13 in the exemplary embodiment can be a Bluetooth tag, a near field communication (NFC) device, or any other suitable communication device. The proximity device 25 can be integral with or secured to the EV charging station 13, on the exterior of the EV charging station 13, for example. Proximity between the proximity device 25 associated with the EV charging station 13 and the user device 22 associated is inferred when the proximity device 25 pairs with the user device 22. It is understood and appreciated that other ways of establishing the proximity relationship between the EV charging station 13 and the user's vehicle 26 will be apparent to those skilled in the art.

The user device 22 is configured to transmit an identification signal including information identifying the user 24, the user device 22, or a user's vehicle 26 connected to the EV charging station 13, when the user device 22 is in proximity of and in communication with the proximity device 25. The user device 22 is further configured to receive a halt signal including a halt charging request message.

The user device 22 may be further configured to transmit a compliance signal that includes compliance data indicating an acceptance or rejection of the halt charging request to be received by at least one of the management device 15, the vehicle 26, and the EV charging station 13 as described below.

The process steps which the user device 22 is configured to perform are discussed below in more detail. In the disclosed embodiment, the user device 22 is configured to perform the steps by way of the appropriate instructions stored on the non-transient storage medium of the portable computing device's ECU.

The management device 15 is configured to receive the identification signal, to identify a set of users 24 whose vehicles 26 are connected to the plurality of EV charging stations 13 on the basis of the identification signal, to determine a current level of consumption of electric power by the facility 10, to compare the current level of consumption of electric power by the facility 10 with a first threshold level, and to transmit the halt signal including the halt charging request message when the current level of consumption of electric power by the facility 10 exceeds the first threshold level.

The management device 15 may be further configured to receive the compliance signal, and to store compliance data indicating an acceptance or rejection of past halt charging requests for a plurality of users 24. Based on the stored compliance data, a set of users 24 who historically accept the halt charging request (hereinafter referred to as the set of compliant users 24) is identified by the management device 15 out of the entire set users 24 whose vehicles 26 are connected to the one or more EV charging stations 13 of the facility 10. The management device 15 directs the transmission of the halt signal including the halt charging request message to the identified set of compliant users 24 when the current level of consumption of electric power by the facility 10 exceeds the first threshold level.

The process steps which the management device 15 is configured to perform are discussed below in more detail. In the disclosed embodiment, the server computer 16 and/or the portable computing device 17 are configured to perform the steps by way of the appropriate instructions stored on the non-transient storage medium of the ECU.

With reference now to FIGS. 3-7, a method for controlling power by the facility 10 that includes the plurality of EV charging stations 13 is shown and described. In the drawings, like reference numbers and numerals indicate like method steps throughout the various views.

At step S101, the management device 15 associated with the facility 10 receives an identification signal including information identifying a user 24, a user device 22, or a user's vehicle 26 connected to the EV charging station 13. For example, to identify the user 24, the identification signal may include information such as the user's name, a unique name associated with the user 24, an employee number associated with the user 24, etc. To identify the user device 22, the identification signal may include information such as the phone number of the user device 22, a serial number associated with the user device 22, an asset tag number associated with the user device 22, etc. To identify the user's vehicle 26, the identification signal may include information such as the vehicle license plate number, the vehicle identification number (VIN), the make, model and color of the vehicle, etc.

In the disclosed embodiment, the identification signal is sent by the user device 22 over a communication network such as the cellular communication network 23. The identification signal is received by the server computer 16 and/or the portable computing device 17 operated by the facility manager 20. The sending and receiving done via the communication network may include the use of communication resources such as the internet and/or a local area network (LAN).

In addition, at step S101a, shown in FIG. 3, the management device 15 may receive a charging signal indicating an exchange of power from one of the plurality of EV charging stations 13 to the user's vehicle 26. The charging signal may originate from the user device 22 or the EV charging station 13, and may be sent via the communication network, the internet, the LAN, or with any other suitable communication device, system, protocol or methods known to those skilled in the art, including combinations thereof.

With ongoing reference again to FIGS. 3-7, at step S102, the management device 15 identifies a set of users 24 whose vehicles 26 are connected to the plurality EV charging stations 13. The set of users 24 whose vehicles 26 are connected to the plurality of EV charging stations 13 may be identified on the basis of the identification signal, where the information received is stored in a database on the management device 15, a “cloud” storage system, or other suitable devices or methods known to those skilled in the art.

At step S103, a current level of consumption of electric power by the facility 10 is determined. The current level of power consumption by the facility 10 may be determined by an appropriate measuring device in communication with the management device 15, for example by a smart meter of the facility 10 in communication, via cellular, internet, or other methods, with the server computer 16 and/or the portable computing device 17, or by other advanced metering infrastructures known to those skilled in the art.

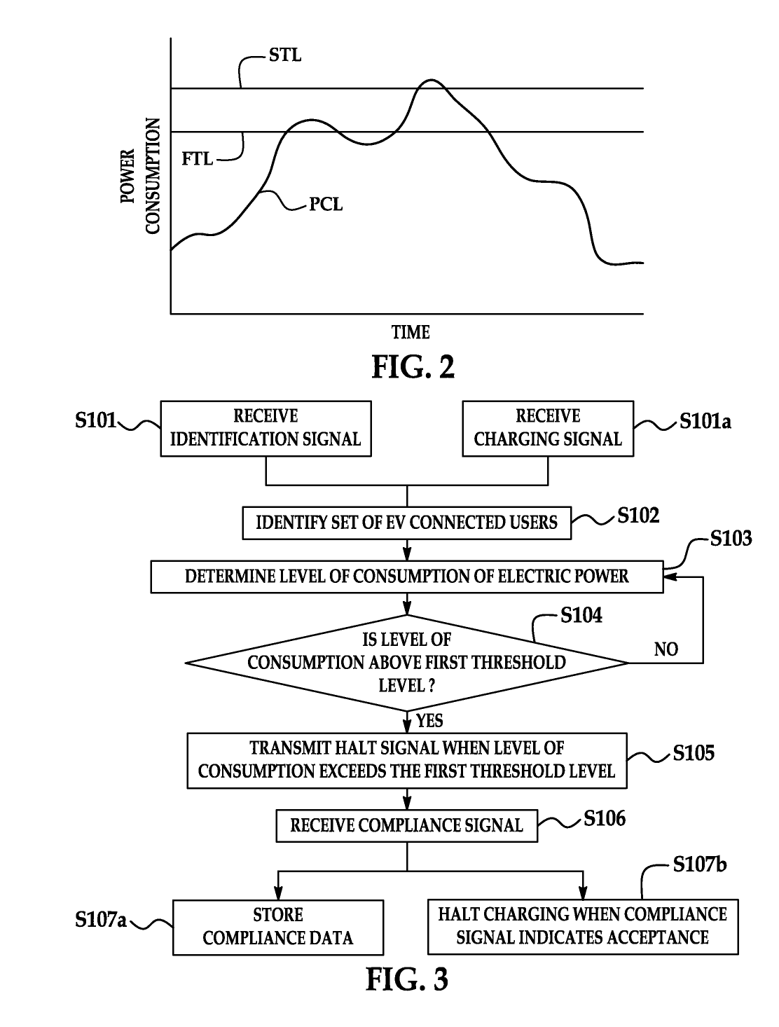

At step S104, the current level of consumption of electric power by the facility is compared with a first threshold level. With reference to FIG. 2, an illustrative graph of power consumption over time is shown. In the graph, a power consumption line PCL depicts a passage of time from left to right, and a variation of power consumption from top to bottom, with a higher location on the graph indicating higher power consumption. Also in the graph is a first threshold level FTL. When the PCL is above the FTL, power consumption is greater than the first threshold.

Steps S103 and S104 may be condensed into a single operation of determining when the current level of power consumption by the facility 10 exceeds the first threshold. Such a determination may be made by the management device 15 receiving an appropriate signal with information indicating when the first threshold has been exceeded. For example, an energy management system which communicates with the utility company, where the utility company sends a warning signal which is received by the management device 15 when the power threshold is reaching the pre-set limit(s).

At step S105, the management device 15 transmits a halt signal including a halt charging request message when the current level of power consumption by the facility 10 exceeds the first threshold level. The halt charging request message contains information suitable to be received by the user device 22 which indicates to the user 24 that it is desired for the user's vehicle 26 to halt charging at the EV charging station 13, and requests an acceptance or rejection for the user 24 as to whether it is permissible to halt the charging of the user's vehicle 26.

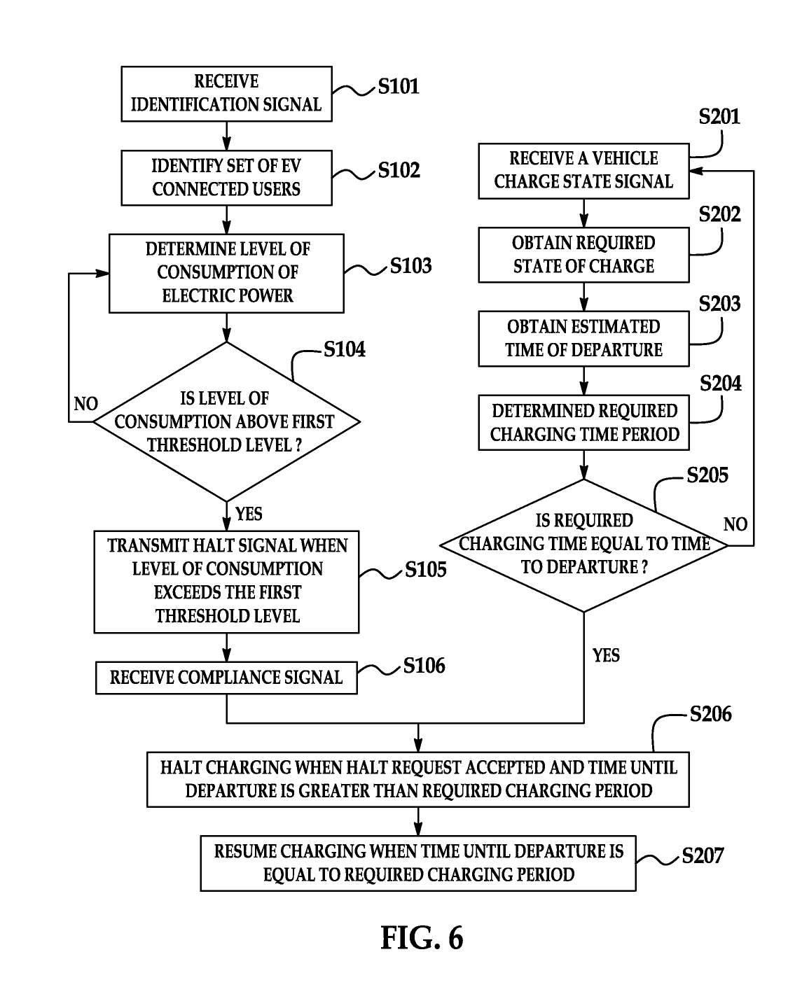

With reference to FIGS. 3 and 6, at step S106, the management device 15 receives a compliance signal that includes compliance data indicating an acceptance or rejection of the halt charging request.

With reference to FIG. 3, at step S107a, the management device 15 stores past compliance data which may include an indication of acceptance or rejection of the halt charging request, and identification information for the user 24 accepting or rejecting the request. The compliance data may be stored in an electronic database located on the management device 15, in the “cloud”, or in any other suitable location accessible by the management device 15.

At step S107b, the EV charging station 13 is controlled to halt charging the vehicle 26 when the received compliance signal indicates acceptance, meaning the user 24 is communicating consent to halt the charging of the user's vehicle 26. Control of the EV charging station 13 may be performed by the management device 15, by the user device 22, manually at the EV charging station 13, or by any other suitable method, device or system known to those skilled in the art.

In addition to using the compliance data to halt the charging by the EV charging station 13, the compliance data may be used to target the transmission of the halt signal to a specified set of users 24.

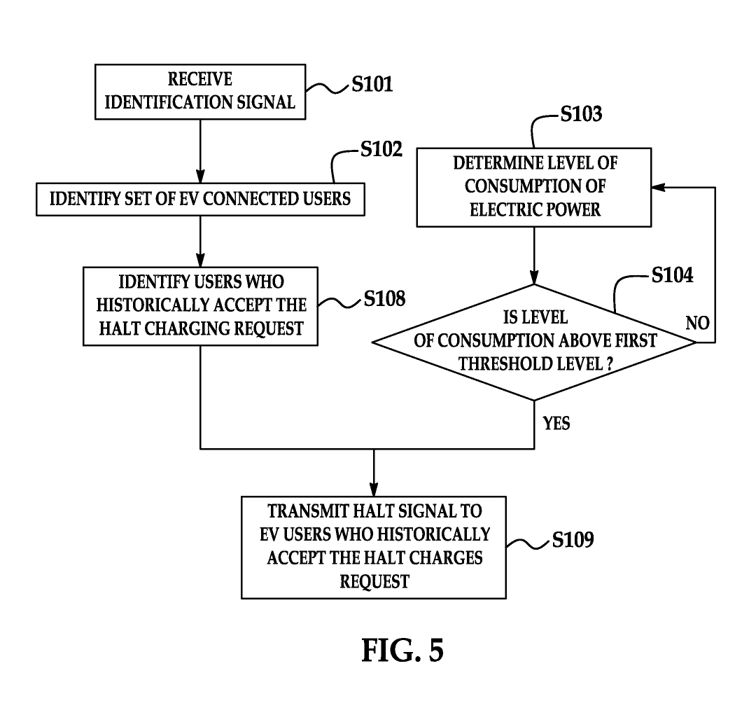

With reference to FIG. 5, in step S108, users 24 who historically accept the halt charge request (the set of compliant users) are identified out of the entire set of users 24 whose vehicles 26 are connected to EV charging stations 13. This identification of the set of compliant users is done on the basis of the stored compliance data indicating an acceptance or rejection of past halt charging requests. For example, a ratio of acceptances and rejections stored on the database for a particular user 24 may be calculated and compared to a predetermined limit, or to ratios from other users 24. In another example, users 24 who have indicated consistent acceptance over a predetermined period of time or number of requests may be identified. Acceptance can be identified from receipt of a compliance signal indicating permission to halt charging, or manual operation of the EV charging station 13 to halt charging the vehicle 26, in response to receiving the halt charging request message.

At step S109, the transmission of the halt signal including the halt charging request message when the consumption of electric power by the facility exceeds the first threshold is directed to the identified set of compliant users. The transmission may be directed to a specific user 24 through the use of that user's telephone number, email address, unique name etc.

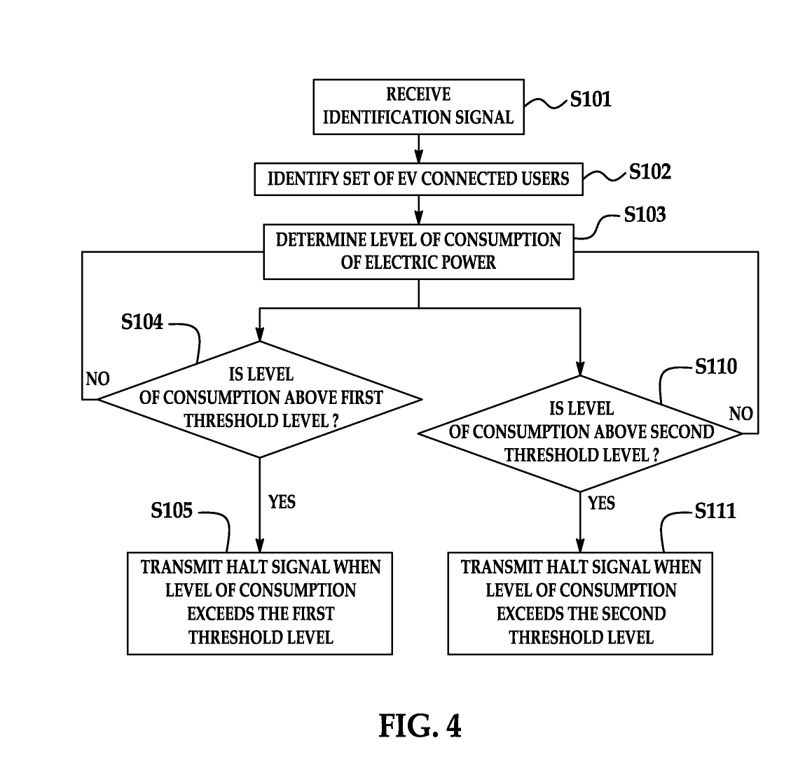

With reference to FIG. 4, in addition to the first threshold discussed above, a second threshold may be used to help reduce power consumption of the facility. Specifically, in step S110 the current level of electric power consumption by the facility is compared with a second threshold level. Comparison of the electric power consumption with the second threshold level is similar to the above described comparison with the first threshold level. The second threshold level is higher than the first threshold level, as shown in FIG. 2, where the second threshold level is represented by the line STL. The first threshold level and second threshold level enable the halt signal to be directed to different sets of users 24. For example, when the second threshold level is exceeded, the halt signal may be transmitted to the entire set of users 24 or a larger set of users 24 as compared to the set of compliant users to whom the halt signal was sent when the first threshold level was exceeded.

At step S111, the halt signal including the halt charging request, is transmitted to the entire set of users 24 whose vehicles are connected to the plurality of EV charging stations 13 when the current level of consumption of electric power by the facility 10 exceeds the second threshold. The transmission may be directed to a specific user 24 through the use of that user's telephone number, email address, unique name etc.

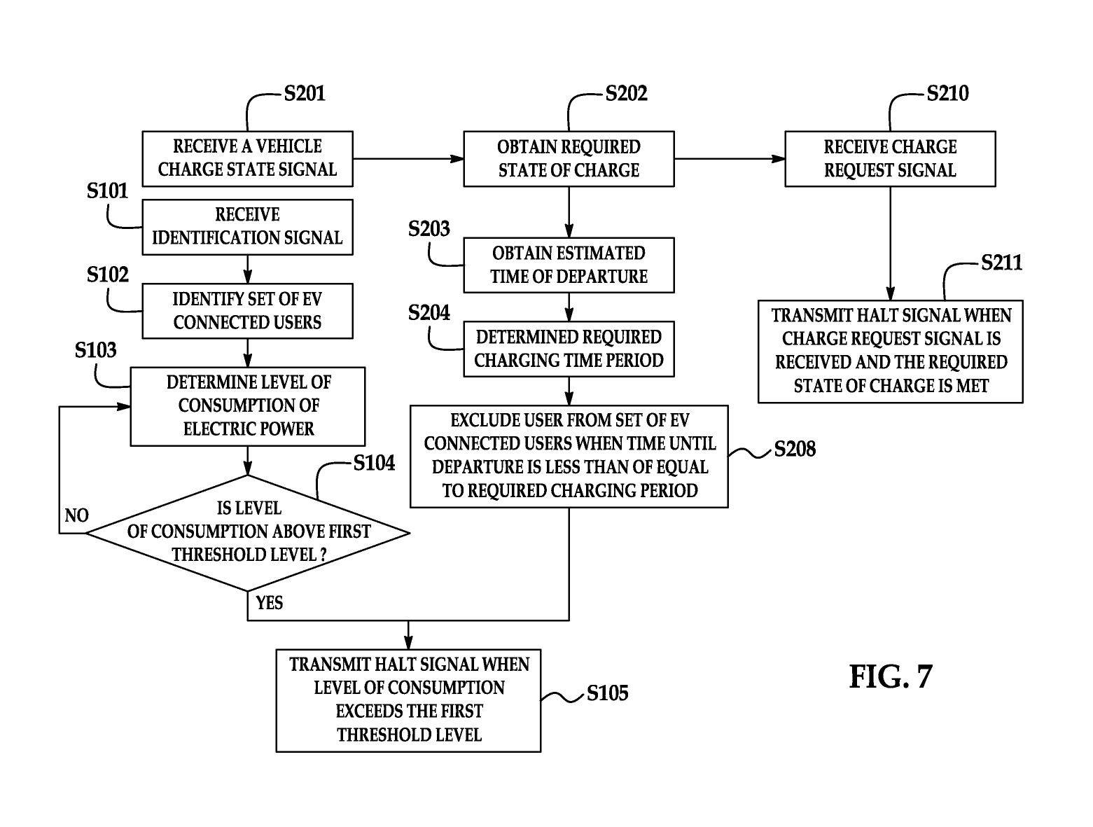

With reference now to FIGS. 6 and 7, power consumption of the facility 10 may further be controlled by taking into account the power storage needs of the vehicles 26 connected to the EV charging stations 13. At step S201, the management device 15 receives a vehicle charge state signal including information indicating a state of charge of the user's vehicle 26 connected to one of the plurality of EV charging stations 13. The state of charge of the user's vehicle 26 may be determined by an internal telematics system of the vehicle 26, and communicated to the management device 15 using the user device 22 as a conduit. For example, where the vehicle 26 includes a Bluetooth device in a head unit of the vehicle 26, the head unit gathers the state of charge information and sends it to the user device 22, the user device 22 sends the information to be received by the management device 15. Alternately, the state of charge may be determined by the EV charging station 13 when the EV charging station is connected to the vehicle 26, the EV charging station 13 sending the information to be received by the management device 15.

At steps S202 and S203, a required state of charge for the user's vehicle 26 and the estimated time of departure of the user's vehicle 26 are obtained. One method to obtain the required state of charge and the estimated time of departure is for the user 24 to input the information into the user device 22, and for the user device 22 to send the information to be received by the management device 15. Another method to obtain the required state of charge and the and the estimated time of departure is for the user 24 to input the information into a user interface on the EV charging station 13, and for the EV charging station 13 to send the information to be received by the management device 15.

At step S204, a required charging time period for achieving the required state of charge for the user's vehicle 26 is determined. One method of determining the required charging period is a calculation based on the required state of charge and a known charging rate of the vehicle 26 connected to the EV charging station 13.

At step S205, the required charging time period is compared to the amount of time until the estimated time of departure. In the disclosed embodiment, such comparison is performed by the management device 15, specifically the server computer 16 and/or the portable computing device 17.

With reference to FIG. 6, at step S206, the EV charging station 13 is controlled so as to halt charging the vehicle 26 when the compliance signal indicating permission to halt charging is received and when the difference between the current time and the estimated time of departure is greater than the determined required charging period. Control of the EV charging station 13 may be performed by the management device 15, manually by the user 24 or the facility manager 20, or by any other suitable method or device known to those skilled in the art.

At step S207, the EV charging station 13 is controlled so as to resume charging the vehicle 26 when the difference between the current time and the estimated time of departure becomes equal to or greater than the determined required charging period. The EV charging station 13 can also be controlled to resume charging the vehicle 26 when the level of power consumption drops below the first threshold. Control of the EV charging station may be performed by the management device 15, manually by the user 24 or the facility manager 20, or by any other suitable method or device known to those skilled in the art.

With reference to FIG. 7, the required charging period from step S204 and the estimated time of departure from step S203 may also be used to further limit the set of users to whom the halt signal is directed. Specifically, at step S208, users 24 whose vehicles 26 are connected to the EV charging stations 13 are excluded from the set of compliant users, to whom the halt charging request message will be sent, when the difference between the current time and the estimated time of departure is less than or equal to the required charging period. For example, to exclude a user 24, the user 24 may be flagged or in the appropriate database so as to easily identify and exclude them from the identified set of compliant users.

At step S209, after the exclusionary step S208, the halt signal including the halt charging request message is directed to the limited set of compliant users. The transmission may be directed to a specific user 24 through the use of that user's telephone number, email address, unique name etc. The halt signal is then transmitted when the level of power consumption exceeds the first threshold, step S105.

Also with reference to FIG. 7, in addition to provided reduced power consumption by enabling communication and information flow between the user and the facility 10, the system and method also provide reduced power consumption by enabling communication and information flow between various users 24. Specifically, at step S210, the management device 15 receives a charge request signal. The charge request signal may be sent from the user device 22 of a first user 24 and include information indicating that the first user 24 desires to charge their vehicle 26 at one of the EV charging stations 13.

The management device 15, at step S211, then transmits the halt signal to a second user device 22 in response to receiving the charge request signal by the management device 15. Additionally, at step S211, the management device 15 can determine whether the state of charge of the second user's vehicle 26 connected to the EV charging station 13 equals the required state of charge for the second user's vehicle 26, and limit the halt signal to be sent to the second user device 22 only when the second user's vehicle 26 equals the required state of charge for the second user's vehicle 26.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A method for controlling power consumption by a facility that includes a plurality of EV charging stations, the facility associated with a management device, the method comprising:
receiving, by the management device, an identification signal including information identifying at least one of a user, a user device, or a user's vehicle connected to one of the plurality of EV charging stations;
identifying, by the management device, in part on the basis of the identification signal, a set of users whose vehicles are connected to the plurality EV charging stations;
determining, by the management device, when a current level of power consumption by the facility exceeds a first threshold; and
transmitting, by the management device, a halt signal including a halt charging request message when the current level of power consumption by the facility exceeds the first threshold level.

2. The method of claim 1, further comprising:
receiving, by the management device, a compliance signal that includes compliance data indicating at least one of an acceptance and a rejection of the halt charging request.

3. The method of claim 2, further comprising:
storing, by the management device, past compliance data.

4. The method of claim 3, further comprising:
identifying, out of the set of users whose vehicles are connected to the plurality of EV charging stations, based on stored past compliance data, a set of users who historically accept the halt charging request; and
wherein the transmitting of the halt signal is directed to the identified set of users who historically accept the halt charging request when the current level of consumption of electric power by the facility exceeds the first threshold level.

5. The method of claim 1, further comprising:
comparing the current level of power consumption by the facility with a second threshold level; and
transmitting the halt signal for a second time when the current level of consumption of electric power by the facility exceeds the second threshold level;
wherein the transmitting of the halt signal for the second time is directed to the identified set of users whose vehicles are connected to the plurality of EV charging stations when the current level of consumption of electric power by the facility exceeds the second threshold level.

6. The method of claim 1, further comprising:
receiving a charging signal indicating an exchange of power from one of the plurality of EV charging stations.

7. The method of claim 2, further comprising:
controlling the EV charging station to halt charging when the received compliance signal indicates acceptance of the halt charging request.

8. The method of claim 1, further comprising:
receiving a vehicle charge state signal including information indicating a state of charge of a user's vehicle connected to one of the plurality of EV charging stations;
obtaining a required state of charge for the user's vehicle connected to one of the plurality of EV charging stations; and
determining a required charging time period for achieving the required state of charge for the user's vehicle connected to one of the plurality of EV charging stations based on the vehicle charge state signal and the required state of charge.

9. The method of claim 8, further comprising:
obtaining an estimated time of departure for the user's vehicle connected to one of the plurality of EV charging stations.

10. The method of claim 9, further comprising:
excluding users from the identified set of users whose vehicles are connected to the plurality of EV charging stations when the difference between a current time and the estimated time of departure for the user's vehicle connected to one of the plurality of EV charging stations is less than or equal to the determined required charging time period;
wherein the transmitting of the halt signal is directed to the set of users whose vehicles are connected to the plurality of EV charging stations when the current level of consumption of electric power by the facility exceeds the first threshold level.

11. The method of claim 9, further comprising:
controlling one of the plurality of EV charging stations to halt charging when a received compliance signal indicates acceptance of the halt charging request and when the difference between a current time and the estimated time of departure for the user's vehicle connected to the one of the plurality of the EV charging stations is greater than the determined required charging period; and
controlling the one of the plurality of the EV charging stations to resume charging when the difference between the current time and the estimated time of departure for the user's vehicle connected to the one of the plurality of the EV charging stations becomes equal to the determined required charging period.

12. The method of claim 1, further comprising:
receiving a vehicle charge state signal including information indicating a state of charge of a user's vehicle connected to one of the plurality of the EV charging stations;
obtaining a required state of charge for the user's vehicle connected to one of the plurality of the EV charging stations;
receiving a charge request signal; and
transmitting a halt signal is response to the charge request signal when the state of charge of the user's vehicle connected to the one of the plurality of EV charging stations equals the required state of charge for the user's vehicle.

13. A system for controlling power consumption by a facility including a plurality of EV charging stations, the system comprising:
a management device;
a proximity device associated with one of the plurality of EV charging stations; and
a user device in communication with the management device;
the user device configured to transmit an identification signal including information identifying at least one of the user, the user's device, or a user's vehicle connected to one of the plurality of EV charging stations, the transmission of the identification signal occurs when the user device is in proximity of the proximity device;
the user device further configured to receive a halt signal including a halt charging request message; and
the management device configured to receive the identification signal, to identify a set of users whose vehicles are connected to the plurality of EV charging stations on the basis of the identification signal, to determine when a current level of power consumption by the facility exceeds a first threshold, and to transmit the halt signal when the current level of power consumption by the facility exceeds the first threshold level.

14. The system of claim 13, wherein the proximity device is a blue-tooth tag secured to an exterior of the one of the plurality of EV charging stations.

15. The system of claim 13, wherein the user device is a portable computing device configured to communicate via a cellular network.

16. The system of claim 13, wherein the management device is a server computer.

17. The system of claim 13, wherein the management device is a portable computing device.

18. The system of claim 17, wherein the portable computing is configured to communicate via a cellular network.

19. The system of claim 13, wherein a smart meter is used in combination with the management device to determine when a current level of power consumption by the facility exceeds a first threshold.

20. The system of claim 13, wherein the management device receives a warning signal to determine when a current level of power consumption by the facility exceeds a first threshold.
